(19) United States
(12) Patent Application Publication
(10) Pub. No.: US 2013/0312520 A1
(43) Pub. Date: Nov. 28, 2013

(54) SENSOR SYSTEM COMPOSED OF ROTATION-RATE SENSOR AND A SENSOR CONTROLLING IT

(71) Applicant: Rex Kho, Holzkirchen (DE)

(72) Inventor: Rex Kho, Holzkirchen (DE)

(21) Appl. No.: 13/992,560

(22) PCT Filed: Nov. 3, 2011
(86) PCT No.: PCT/EP11/69310

§ 371 Date: Aug. 15, 2013

(30) Foreign Application Priority Data
Dec. 8, 2010 (DE) 10 2010 062 581.7

(51) Int. Cl. G01C 19/56; G01P 15/02

(52) U.S. Cl. CPC G01C 19/56; G01P 15/02
USPC 73/504.12; 73/514.15

(57) ABSTRACT

A rotational rate sensor is provided having a substrate and having a seismic mass that is movable relative to the substrate, the seismic mass being capable of being excited by a drive unit to a working oscillation relative to the substrate, and a Coriolis deflection of the seismic mass perpendicular to the working oscillation being capable of being detected, the rotational rate sensor having an interface for sending out a sensor signal as a function of the Coriolis deflection, the drive unit being configured for the modification of a frequency and/or of an amplitude of the working oscillation when a control signal is present at the interface.

### FIELD

The present invention is based on a rotational rate sensor.

### BACKGROUND INFORMATION

Conventional rotational rate sensors are generally available. German Patent Application No. DE 195 19 488 A1 describes a rotational rate sensor is known having a first and a second oscillating mass, the first and second oscillating mass each being excited to a working oscillation by an excitation device, a first Coriolis deflection of the first oscillating mass and a second Coriolis deflection of the second operating mass each being acquired by evaluation means, and being correspondingly differentially evaluated in order to determine the rotational rate. In the present case this uses a so-called active sensor, because for the measurement of the Coriolis deflections the first and the second oscillating mass must constantly be excited to a working oscillation. The rotational rate sensor therefore disadvantageously consumes energy even when no rotational rate to be measured is present.

### SUMMARY

An example rotational rate sensor according to the present invention, an example sensor system according to the present invention, an example method according to the present invention for operating a rotational rate sensor, and an example method according to the present invention for operating a sensor system may have the advantage that the energy consumption of the rotational rate sensor is reduced as soon as the control signal (in particular an interrupt signal) is present at the rotational rate sensor, no additional pin being required at the rotational rate sensor for the transmission of the control signal; rather, the existing pins on the rotational rate sensor can be used.

This advantage is achieved by a rotational rate sensor having a substrate and a seismic mass that is movable relative to the substrate, the seismic mass being capable of being excited by a drive unit to a working oscillation relative to the substrate, and a Coriolis deflection of the seismic mass perpendicular to the working oscillation being detectable, the rotational rate sensor having an interface for sending out a sensor signal as a function of the Coriolis deflection, the drive unit being configured for the modification of a frequency and/or of an amplitude of the working oscillation when a control signal is present at the interface.

Advantageously, the interrupt signal is applied to the rotational rate sensor itself via the interface for sending out the sensor signal, thus directly causing a modification of the frequency and/or of the amplitude of the working oscillation in order to reduce the energy consumption of the rotational rate sensor, without requiring additional external control units such as microcontrollers or processors for switching on an energy savings mode of the rotational rate sensor. In this context, modification includes the reduction and the increasing of the frequency and/or of the amplitude of the working oscillation. In this way, on the one hand the energy consumption of such external control units is saved, and on the other hand the energy consumption reduction at the rotational rate sensor is introduced significantly more quickly (in particular without detours via the external control units). In addition, it is possible for the external control units already to be switched into an energy-saving mode temporally before the rotational rate sensor; in this way, the overall energy consumption can be further reduced. A reduction in the frequency and/or the amplitude of the working oscillation in the sense of the present invention means in particular that the rotational rate sensor is switched from an operating mode into an energy saving mode, in particular a sleep mode, in which the working oscillation is completely switched off (frequency and amplitude essentially equal to zero), or into a low-power mode in which a working oscillation operates with reduced energy consumption (frequency and/or amplitude reduced relative to a normal operating mode). The interrupt signal is preferably produced by an external component that in particular includes a passive sensor, so that the energy consumption caused by the external component is lower than the energy consumption caused by the rotational rate sensor in the operating mode. The passive sensor for example includes an acceleration sensor that produces the interrupt signal at the interface if no acceleration forces are measurable and/or the measured acceleration forces do not exceed a specific threshold value. In this way, it is preferably ensured that no rotational rate measurable by the rotational rate sensor is present, and for this reason the switching of the rotational rate sensor into the energy saving mode is justified without “overlooking” rotational rates that are to be measured. The rotational rate sensor preferably includes a micromechanical rotational rate sensor, the substrate including a semiconductor substrate, in particular. silicon. The interface preferably includes a connecting pin of the rotational rate sensor that acts as an electrical contact, and in particular as a simple plug contact.

Advantageous embodiments and development of the present invention are described below with reference to the figures.

According to a preferred development, it is provided that the rotational rate sensor has a switching unit that is functionally coupled to the interface and to the drive unit, the switching unit being configured to detect the control signal, and the switching unit being configured to control the drive unit as a function of the control signal in such a way that when the control signal is detected a modification of the frequency and/or of the amplitude of the working oscillation is provided. In this way, a comparatively simple realization of the rotational rate sensor is advantageously possible.

A further subject matter of the present invention relates to a sensor system having a rotational rate sensor as recited in one of the preceding specific embodiments and having a sensor, the rotational rate sensor being coupled to the sensor via the interface, the sensor being configured to output the control signal via the interface as a function of a sensor signal. In this way, it is advantageously possible to reduce the energy consumption Of the rotational rate sensor as soon as the control signal (in particular an interrupt signal) is present at the rotational rate sensor, no additional pin being required on the rotational rate sensor for transmitting the control signal; rather, the existing pins on the rotational rate sensor can be used.

According to a preferred development, it is provided that the sensor is configured to output the control signal via the interface as a function of a comparison of the sensor signal with a sensor threshold value. In this way, a comparatively simple realization of the sensor system is advantageously possible. In addition, it is preferred that the sensor has an acceleration sensor and/or a proximity sensor. Through the use of, e.g., passive sensors, a comparatively large reduction of the energy consumption of the sensor system is possible.

A further subject matter of the present invention relates to a method for operating a rotational rate sensor, in particular according to one of the preceding specific embodiments, a seismic mass being excited to a working oscillation by a drive unit, and a Coriolis deflection of the seismic mass perpendicular to the working oscillation being detected, a frequency and/or amplitude of the working oscillation being modified when a control signal is detected at an interface configured to send out a sensor signal as a function of the Coriolis deflection. In this way, it is advantageously possible for the energy consumption of the rotational rate sensor to be reduced as soon as the control signal (in particular an interrupt signal) is present at the rotational rate sensor, no additional pin being required on the rotational rate sensor for transmitting the control signal; rather, the existing pins on the rotational rate sensor can be used.

According to a preferred development, it is provided that, using a switching unit, the interface is monitored for the presence of the control signal, and that, using the switching unit, the drive unit is controlled in such a way that when the control signal is detected the frequency and/or the amplitude of the working oscillation are modified. In this way, a comparatively simple realization of the method is advantageously possible. It is further preferred that the frequency and/or the amplitude of the working oscillation be reduced so far that the working oscillation is stopped. Through the stopping as needed of the working oscillation, a comparatively large reduction of the energy consumption of the rotational rate sensor is possible.

A further subject matter of the present invention relates to a method for operating a sensor system having a rotational rate sensor and having a sensor, the rotational rate sensor being operated using a method according to one of the preceding exemplary embodiments, and the control signal being produced by the sensor. In this way, it is advantageously possible for the energy consumption of the rotational rate sensor to be reduced as soon as the control signal (in particular an interrupt signal) is present at the rotational rate sensor, no additional pin being required on the rotational rate sensor for transmitting the control signal; rather, the existing pins on the rotational rate sensor can be used.

According to a preferred development, it is provided that the control signal is produced as a function of a comparison of a sensor signal with a sensor threshold value, the control signal preferably being produced when a specified acceleration value is undershot. In this way, a comparatively simple realization of the method is advantageously possible.

Exemplary embodiments of the present invention are shown in the figures and are explained in more detail in the description below.

### BRIEF DESCRIPTION OF THE DRAWINGS

FIG. 1 shows a schematic view of a sensor system according to a specific embodiment of the present invention.

FIG. 2 schematically shows a sensor system according to a further exemplary specific embodiment of the present invention.

FIG. 3 schematically shows a sensor system according to a further exemplary specific embodiment of the present invention.

FIG. 4 schematically shows a sensor system according to a further exemplary specific embodiment of the present invention.

FIG. 5 schematically shows signal curves of an exemplary specific embodiment of the method according to the present invention.

### DETAILED DESCRIPTION OF EXAMPLE EMBODIMENTS

In the figures, identical parts are provided with the same reference characters, and are therefore generally each only named or mentioned once.

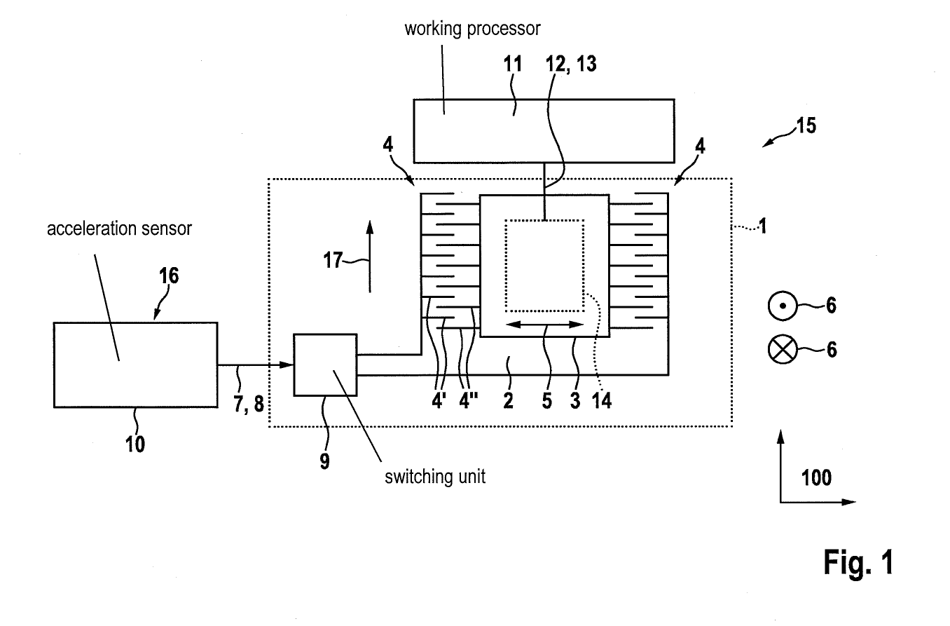

FIG. 1 shows a schematic view of a sensor system 15 according to a first specific embodiment of the present invention. Sensor system 15 includes a micromechanical rotational rate sensor 1, shown only schematically and as an example, as well as a passive sensor 10 in the form of a micromechanical acceleration sensor 10. Rotational rate sensor 1 includes a substrate 2 and a seismic mass 3 (often also called a Coriolis element or sensor element) suspended so as to be movable relative to substrate 2. Seismic mass 3 is excited to a working oscillation 5 by capacitive drive units 4; in the present example, the oscillation is oriented parallel to a main plane of extension 100 of substrate 2.

Drive units 4 include for this purpose finger electrode structures 4′ fixed to the substrate, between which there engage counter-electrodes 4″, fashioned as finger electrodes, of seismic mass 3. Due to electrostatic interaction between finger electrode structures 4′ and counter-electrodes 4″, an alternating voltage applied on each side of seismic mass 3, between each of finger electrode structures 4′ and counter-electrodes 4″, produces a drive force on seismic mass 3 that induces the working oscillation. If a rotational rate 17 is present that is oriented perpendicular to working oscillation 5 and parallel to main plane of extension 100, on seismic mass 3 there acts a Coriolis force perpendicular to main plane of extension 100, causing a Coriolis deflection 6 of seismic mass 3 perpendicular to main plane of extension 100. Coriolis deflection 6 is a measure of rotational rate 17 that is to be measured, and is capacitively measured by surface electrode elements 14 that are situated for example between seismic mass 3 and substrate 2. Output signal 13, which is a function of Coriolis deflection 6, is sent via a data interface 12 to a working processor 11 that is provided for the further processing of output signal 13. Data interface 12 includes in particular a digital interface, so that output signals 13 are communicated to working processor 11 as digital data. If no rotational rate 17 is present, and in particular no rotational rate 17 was measured over a specified time interval, then in order to save energy rotational rate sensor 1 is to be switched from the described operating mode into an energy-saving mode through a reduction of the frequency and/or of the amplitude of working oscillation 5. The energy-saving mode includes in particular a sleep mode in which working oscillation 5 is completely switched off (frequency and amplitude generally equal to zero), or a low-power mode in which a working oscillation 5 operates with reduced energy consumption (frequency and/or amplitude reduced relative to a normal operating mode). For this purpose, rotational rate sensor 1 has an interface 7. Interface 7 is coupled to a switching unit 9 that monitors interface 7 intermittently or continuously for the present of an interrupt signal 8. Switching unit 9 is further coupled to drive units 4, drive units 4 being controlled by switching unit 9 in such a way that rotational rate sensor 1 is set to the energy-saving mode, i.e., the frequency and/or the amplitude of working oscillation 5 are reduced or are set to zero, as soon as an interrupt signal 8 is detected at interface 7. Rotational rate sensor 1 is subsequently preferably held in the energy state for as long as interrupt signal 8 is present at interface 7. When, at a later time, interface 7 is again free of interrupt signal 8, rotational rate sensor 1 is set back into the operating mode, i.e., drive units 4 are controlled in such a way that working oscillation 5 is again activated and/or the frequency and/or the amplitude of working oscillation 5 are reset to the initial value. Interrupt signal 8 is switched on or off by passive sensor 10 (also designated an external component), which preferably includes a micromechanical acceleration sensor. An acceleration value measured by the acceleration sensor, in the form of a sensor signal, is compared to a sensor threshold value. Interrupt signal 8 is produced when the acceleration value falls below the sensor threshold value (in particular for a particular time span), because in this case no rotational rate 17 to be measured by rotational rate sensor 1 is present. In the case in which the sensor threshold value is exceeded by the acceleration value, interrupt signal 8 is discontinued so that rotational rate sensor 1 can carry out a rotational rate measurement. It is possible that rotational rate sensor 1 also be fashioned in a manner fundamentally different from rotational rate sensor 1 shown in FIG. 1 as an example. For example, a realization is also possible having a differentially operating rotational rate sensor 1, having two seismic masses 3 and/or having a multichannel rotational rate sensor 1 provided for the measurement of an additional rotational rate 17 perpendicular to the main plane of extension 100 and/or perpendicular to working oscillation 5. In addition, a realization of drive units 4 in the form of plate capacitor drives and the like is conceivable.

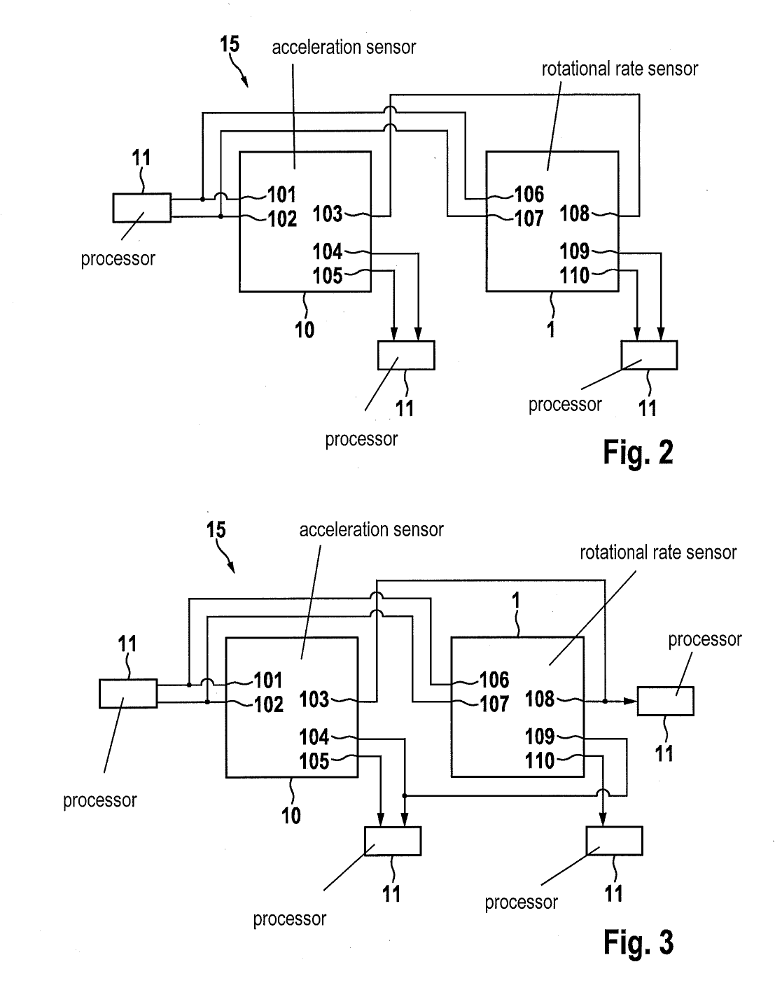

FIGS. 2 through 4 schematically show sensor system 15 according to further exemplary specific embodiments of the present invention. Sensor system 15 has an acceleration sensor 10 (accelerometer) and a rotational rate sensor 1 (gyroscope). Acceleration sensor 10 has a first pin 101 (data input “SDI”), a second pin 102 (for clock signal “SCK” or “SCKL”), a third pin 103 (data output “SDO”), a fourth pin 104 (for an interrupt signal “Int1”), and a fifth pin 105 (for an interrupt signal “int2”). Rotational rate sensor 1 has a sixth pin 106 (data input “SDI”), a seventh pin 107 (for clock signal “SCK” or “SCKL”), an eighth pin 108 (data output “SDO”), a ninth pin 109 (for an interrupt signal “int1”), and a tenth pin 110 (for an interrupt signal “int2”). An application unit or working processor 15 (MC) is connected to first pin 101, to second pin 102, to sixth pin 106, and to seventh pin 107.

In the specific embodiment shown schematically in FIG. 2, third pin 103 and eighth pin 108 are not used as data interface to application unit 15. Eighth pin 108 of rotational rate sensor 1 is superposed in that it is used as input for a sleep signal or wake signal (also called wake-up signal in the following) for rotational rate sensor 1. Third pin 103 of acceleration sensor 10 is superposed in that it is used as output for the sleep/wake signal to rotational rate sensor 1. Fourth pin 104, fifth pin 105, ninth pin 109, and tenth pin 110 are conventionally used as interrupt pins for feedback to application unit 15. Preferably, a serial I²C data bus system (I-squared-C data bus system) is used, the SPI 3 mode being executed.

In the specific embodiment shown schematically in FIG. 3, third pin 103 and eighth pin 108 are conventionally used as data interface to application unit 15. Ninth pin 109 is superposed in that it is used as input for the sleep/wake signal for rotational rate sensor 1. Tenth pin 110 is conventionally used as a single interrupt pin for feedback to application unit 15. Fourth pin 104 and fifth pin 105 are conventionally used as interrupt pins for feedback to application unit 15. In this example, fourth pin 104 can also be used as output for the sleep/wake signal to rotational rate sensor 1. In this specific embodiment, SPI 4 mode is used.

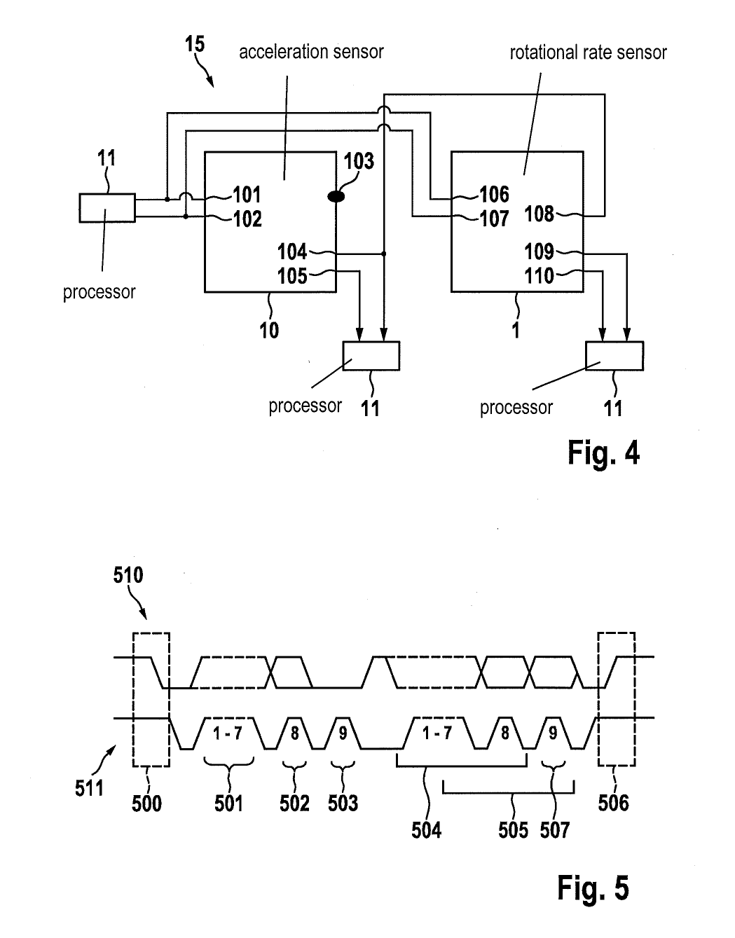

In the specific embodiment shown schematically in FIG. 4, third pin 103 of acceleration sensor 10 is not used. Pin 108 of rotational rate sensor 1 is superposed in that it is used as input for the sleep/wake signal for rotational rate sensor 1. Fourth pin 104, fifth pin 105, ninth pin 109, and tenth pin 110 are conventionally used as interrupt pins for the feedback to application unit 15. In this example, fourth pin 104 can also be used as output for the sleep/wake signal to rotational rate sensor 1. Preferably, as in FIG. 2, a serial I2C data bus system is used, SPI 3 mode being executed.

FIG. 5 schematically shows temporal signal curves of an exemplary specific embodiment of the method according to the present invention. In this specific embodiment, for example third pin 103 and eighth pin 108 are not used as data interface to application unit 15. Eighth pin 108 of rotational rate sensor 1 is superposed in that it is used as input for a sleep/wake signal for rotational rate sensor 1. Third pin 103 of acceleration sensor 10 is superposed in that it is used as output for the sleep/wake signal to rotational rate sensor 1. Fourth pin 104, fifth pin 105, ninth pin 109, and tenth pin 110 are conventionally used as interrupt pins for the feedback to application unit 15. In upper diagram 510, FIG. 5 shows the signal curve of the clock signal (SCK), and in lower diagram 511 FIG. 5 shows the signal curve of the data signal (SDI) for the example of an I²C bus system in SPI 3 mode. In time interval 500, a start signal (S) is transmitted. In time interval 501, with the write command data are written to the “use sdo/int pin as wake signal input” register. (ADRESS) selects the rotational rate sensor Chip. In time interval 502, a read/write bit is transmitted. In time interval 503, 1 bit is transmitted for reception confirmation. After this reception confirmation, the rotational rate sensor uses the sdo/int pin as input for the wake signal. The rotational rate sensor now waits for a wake signal at the sdo/int pin, supplied by the acceleration sensor. In time interval 504, sensor data are transmitted. In time interval 507, 1 bit is transmitted for reception confirmation. Bracket 505 indicates that intervals 504 and 507 are transmitted twice. In time interval 506, a stop signal (P) is transmitted. A similar method is also possible with SPI control signals that use the SPI communication protocol. Preferably, control commands are combined, so that for example the command “set rotational rate sensor to sleep mode” [. . . ] with the command “activate the sdo/int pins as input pins for the wake signal.”

1-10. (canceled)

11. A rotational rate sensor, comprising:
a substrate;
a seismic mass that is movable relative to the substrate;
a drive unit, the seismic mass being capable of being excited by the drive unit to a working oscillation relative to the substrate, and a Coriolis deflection of the seismic mass perpendicular to the working oscillation being capable of being detected; and
an interface to send out a sensor signal as a function of the Coriolis deflection;
wherein the drive unit is configured to modify at least one of a frequency and an amplitude of the working oscillation, when a control signal is present at the interface.

12. The rotational rate sensor as recited in claim 11, wherein the rotational rate sensor has a switching unit that is functionally coupled to the interface and the drive unit, the switching unit being configured to detect the control signal, and the switching unit being configured to control the drive unit as a function of the control signal in such a way that when the control signal is detected, a modification is provided of at least one of the frequency and the amplitude of the working oscillation.

13. A sensor system, comprising:
a rotational rate sensor including a substrate, a seismic mass that is movable relative to the substrate, a drive unit, the seismic mass being capable of being excited by the drive unit to a working oscillation relative to the substrate, and a Coriolis deflection of the seismic mass perpendicular to the working oscillation being capable of being detected, and an interface to send out a sensor signal as a function of the Coriolis deflection, wherein the drive unit is configured to modify at least one of a frequency and an amplitude of the working oscillation, when a control signal is present at the interface; and
a sensor, the rotational rate sensor being coupled to the sensor via the interface, the sensor being configured to output the control signal via the interface as a function of a sensor signal.

14. The sensor system as recited in claim 13, wherein the sensor is configured to output the control signal via the interface as a function of a comparison of the sensor signal with a sensor threshold value.

15. The sensor system as recited in claim 13, wherein the sensor includes at least one of an acceleration sensor and a proximity sensor.

16. A method for operating a rotational rate sensor, the rotational rate sensor including a substrate, a seismic mass that is movable relative to the substrate, a drive unit, the seismic mass being capable of being excited by the drive unit to a working oscillation relative to the substrate, and a Coriolis deflection of the seismic mass perpendicular to the working oscillation being capable of being detected, and an interface to send out a sensor signal as a function of the Coriolis deflection, wherein the drive unit is configured to modify at least one of a frequency and an amplitude of the working oscillation, when a control signal is present at the interface, the method comprising:
exciting a seismic mass to a working oscillation by a drive unit;
detecting a Coriolis deflection of the seismic mass perpendicular to the working oscillation; and
modifying at least one of a frequency and amplitude of the working oscillation when a control signal is detected at an interface configured to send out a sensor signal as a function of the Coriolis deflection.

17. The method as recited in claim 16, further comprising:
monitoring the interface for a presence of the control signal using the switching unit; and
controlling the drive unit in such a way that when the control signal is detected, at least of the frequency and the amplitude of the working oscillation are modified.

18. The method as recited in claim 16, wherein at least one of the frequency and the amplitude of the working oscillation are reduced so far that the working oscillation is stopped.

19. A method for operating a sensor system having a rotational rate sensor and a sensor, wherein the rotational rate sensor includes a substrate, a seismic mass that is movable relative to the substrate, a drive unit, the seismic mass being capable of being excited by the drive unit to a working oscillation relative to the substrate, and a Coriolis deflection of the seismic mass perpendicular to the working oscillation being capable of being detected, and an interface to send out a sensor signal as a function of the Coriolis deflection, wherein the drive unit is configured to modify at least one of a frequency and an amplitude of the working oscillation, when a control signal is present at the interface, the method comprising:
exciting a seismic mass to a working oscillation by a drive unit;
detecting a Coriolis deflection of the seismic mass perpendicular to the working oscillation;
modifying at least one of a frequency and amplitude of the working oscillation when a control signal is detected at an interface configured to send out a sensor signal as a function of the Coriolis deflection; and
producing the control signal by the sensor.

20. The method as recited in claim 19, wherein the control signal is produced as a function of a comparison of a sensor signal with a sensor threshold value, the control signal being produced when a particular acceleration value is undershot.
